(19) United States
(12) Patent Application Publication
(10) Pub. No.: US 2013/0267664 A1
(43) Pub. Date: Oct. 10, 2013

(54) POLYAMIDE-POLYOLEFIN COPOLYMER

(71) Applicant: Stéphane Jeol, Lyon (FR)

(72) Inventor: Stéphane Jeol, Lyon (FR)

(73) Assignee: RHODIA OPERATIONS, Aubervilliers (FR)

(21) Appl. No.: 13/991,889

(22) PCT Filed: Dec. 15, 2011
(86) PCT No.: PCT/EP2011/072927

§ 371 Date: Jun. 5, 2013

(30) Foreign Application Priority Data
Dec. 16, 2010 (FR) 1060618

(51) Int. Cl. C08G 69/48

(52) U.S. Cl. CPC C08G 69/48
USPC 525/418

(57) ABSTRACT

A polyamide-polyolefin block copolymer having a polyamide backbone and one or two polyolefin graft(s) on the backbone is described. Further described, is how the polyolefin graft(s) is (are) attached to the backbone via the residues of a function X-Y resulting from the reaction of a function X located at the polyolefin chain end and capable of reacting with an amine or carboxylic acid function Y of the polyamide.

The present invention relates to a polyamide-polyolefin block copolymer composed of a polyamide backbone and one or two polyolefin grafts on said backbone; in which the polyolefin graft or grafts are attached to the backbone by the residues of a function X-Y; obtained from the reaction of a function X situated at the chain end of the polyolefin and capable of reacting with an amine or carboxylic acid function Y of the polyamide.

### PRIOR ART

Immiscible blends of polyamide and polyolefin have been known for very many years. When the polyamide constitutes the continuous matrix, the dispersed polyolefin, particularly in the form of nodules, contributes a certain number of properties, such as lightening and impact resistance. Nevertheless, the performance levels of PA/polyolefin blends are dependent on the morphology of the blend, in other words on the organization of the two polyamide and polyolefin phases at different scales. In the case of a simple immiscible PA/polypropylene blend, for example, having a majority of polyamide, the polypropylene is coarsely dispersed in the form of macro-objects, most usually nodules, with a size of up to several tens of micrometers. This impacts adversely on certain properties such as the mechanical properties or else the transparency.

The use of compatibilizers in order to promote the dispersion of the polyolefins in a polyamide matrix and thereby to reduce the size of the dispersed phase to a size of from several hundred nanometers to a number of micrometers is known. Most often used for this purpose are polyolefins which carry maleic anhydride functions capable of reacting with the amine functions of the polyamide and thereby of creating greater affinity between the two phases. This then makes it possible to enhance the mechanical performance of the blends, but the principal problem is that the morphology of the resulting blends is highly dependent on the extrusion conditions, such as the temperature and the shear, and subsequently the conditions of use, and so it is very difficult to guarantee a controlled and consistent morphology, and also consistent mechanical properties irrespective of the extrusion and shaping conditions. Moreover, these blends retain properties associated with the very nature of the two polymers, owing to the micrometric character of the dispersed phase.

There is therefore a need to provide PA/polyolefin mixtures having very fine morphologies, in other words having a dispersed phase one of whose dimensions is less than 100 nm (nanostructuring) and morphologies which depend little on the blending conditions and conditions of use.

In order to reduce the size of the dispersed phase, one alternative, developed by Toray, is that of producing nanoalloys, which, however, necessitates means for appropriate extrusion. Another alternative is to produce copolymers like those developed by Arkema, as for example PA-g-polyolefin copolymers, from a polyolefin backbone which carries maleic anhydride functions distributed randomly and pendantly, and from polyamide of low molar masses. These blends are capable of taking on a nanostructure, but suffer from the absence of regularity associated with the random character of the distribution of the maleic anhydride over the polyolefin chain, leading to an absence in regularity of the very structure of the graft copolymers: not all nanostructures can be obtained by this technology, especially highly regular structures.

### INVENTION

The applicant has now found, very surprisingly, that polyamide-polyolefin block copolymers composed of a polyamide backbone and one or two polyolefin grafts on said backbone undergo organization into particular nanometric structures. It is apparent, indeed, that in the matrix composed of these polyamide-polyolefin block copolymers, the polyolefin blocks assemble into nanostructures, i.e., structures having at least one dimension smaller than 100 nm, such as lamellae, strips, vesicles, worms (work-like), or micelles. Such nanostructuring confers remarkable properties exceeding those of conventional blends of two polymers in terms of mechanical properties, thermal stability, solubility, and water absorption behavior.

The applicant has also just developed a simple way of preparing these polyamide-polyolefin block copolymers which are capable of undergoing nanostructuring, by reactive blending of polyamide and particular polyolefin, which is not very dependent on the conditions of extrusion and of use; and, consequently, is readily reproducible.

### PROCESS OF THE INVENTION

The present invention accordingly first provides a process for producing a polyamide-polyolefin block copolymer composed of a polyamide backbone and one or two polyolefin grafts on said backbone; in which the following are contacted in the melt state:
a polyamide having a number-average molar mass Mn PA of between 1000 and 30 000 g/mol; the polyamide has per chain terminal amine and/or carboxylic acid groups;
a polyolefin having a number-average molar mass Mn PO of between 500 and 10 000 g/mol; the polyolefin has per chain a single function X situated at the end of the polyolefin chain; this function X is capable of reacting with an amine and/or carboxylic acid function of the polyamide;
the proportions by mass of polyamide and of polyolefin employed and their molecular weights are a function of the following relation:

n X/n Y is between 0.8 and 1.2

in which:
n X represents the number of moles of function X of the polyolefin
n Y represents the number of moles of the terminal amine and/or carboxylic acid groups of the polyamide capable of reacting with the function X to form a covalent bond.

The process according to the present invention may in particular enable access to the copolymer within a short time, in any case more quickly than the processes which involve reactions in solution, and this is particularly advantageous from an industrial standpoint.

The present invention also relates to polyamide-polyolefin block copolymers obtainable by the process as described above.

These copolymers may be obtained in high purity, in other words at least without being blended with a significant amount of other polymers. This may in particular allow them to have a nanometric structure and improved properties relative to the prior-art copolymers of the same type.

The polyamide-polyolefin block copolymer may be obtained by blending the various constituents hot, as for example in a single-screw or twin-screw extruder, at a temperature sufficient to maintain the polyamide resin and the polyolefin resin in the melt medium; or else cold, in a mechanical mixer in particular. Blending is generally carried out under the action of a shear. Generally, the blend obtained is extruded in the form of rods, which are cut up into pieces to form granules. Additives may be added at any time in the production procedure of the plastic material, in particular by hot or cold blending with the plastic matrix.

The blend may be obtained by any appropriate device such as endless screw mixers or agitator mixers which are compatible with the temperature and pressure conditions used for the use of the polyamides and polyolefins. The melted blend may be shaped before the cooling step, in the form of filaments or rods, for example. This shaping may advantageously be carried out by a process of extrusion through a die. The melted mixture may be cooled by any appropriate means. Among these means, air cooling or immersion in a liquid are preferred.

It is possible accordingly, in an extruder, to knead the polyamide and the polyolefin at a temperature generally of between 100 and 330° C. The average residence time of the melted material in the extruder may be between 15 seconds and 30 minutes, more particularly between 30 seconds and 5 minutes.

The blends of the invention may be prepared by blending in the melt state in extruders (single- or twin-screw), Buss kneaders, Brabender mixers, and, in general, typical devices for blending thermoplastics, and preferably twin-screw extruders. The blends of the invention may further comprise fluidizing agents such as silica, ethylenebisamide, aluminum stearate, calcium stearate, or magnesium stearate. They may also comprise antioxidants, UV stabilizers, inorganic fillers, and coloring pigments. The blends of the invention may be prepared in one or more steps in an extruder.

The polyamide may in particular have a number-average molar mass Mn PA of between 2000 and 20 000 g/mol, more preferably between 5000 and 17 000 g/mol.

Polyamides according to the invention may include semicrystalline or amorphous polyamides and copolyamides, such as aliphatic polyamides, semiaromatic polyamides, and, more generally, linear polyamides obtained by polycondensation of an aliphatic or aromatic saturated diacid and an aliphatic or aromatic saturated primary diamine, polyamides obtained by condensation of a lactam, of an amino acid, or linear polyamides obtained by condensation of a mixture of these various monomers. More specifically, these copolyamides can be, for example, poly(hexamethylene adipamide), polyphthalamides obtained from terephthalic and/or isophthalic acid, or copolyamides obtained from adipic acid, hexamethylenediamine and caprolactam.

The polyamide is preferably selected from the group consisting of polyamides obtained by polycondensation of a linear dicarboxylic acid with a linear or cyclic diamine, such as PA 6.6, PA 6.10, PA 6.12, PA 12.12, PA 10.10, PA 10.2, PA 4.6, and MXD.6, or of an aromatic dicarboxylic diacid and an aromatic or linear diamine, such as polyterephthalamides, polyisophthalamides, polyaramids, polyamides obtained by polycondensation of an amino acid with itself, it being possible for the amino acid to be generated by the hydrolytic opening of a lactam ring, such as, for example, PA 6, PA 7, PA 11, PA 12, and PA 13.

According to one preferred embodiment of the invention, the polyamide matrix comprises at least one polyamide selected from the group consisting of polyamide 6, polyamide 66, polyamide 610, polyamide 11, polyamide 12, polymetaxylylene adipamide (MXD6), and blends and copolymers based on these polyamides.

The composition of the invention can also comprise copolyamides derived in particular from the above polyamides, or the blends of these polyamides or copolyamides.

Use is made generally of polyamides with molecular weights which are suitable for the processes of injection molding, although polyamides with lower viscosities can also be used.

The polyamide may in particular be a copolymer comprising star or H macromolecular chains, and, where appropriate, linear macromolecular chains. Polymers comprising such star or H macromolecular chains are, for example, described in the documents FR 2 743 077, FR 2 779 730, U.S. Pat. No. 5,959,069, EP 0 632 703, EP 0 682 057 and EP 0 832 149. The polyamide may also be a random tree polymer, preferably a copolyamide having a random tree structure. These copolyamides with a random tree structure and their process of preparation are described in particular in the document WO99/03909. The polyamide may also comprise a hyperbranched copolyamide like those described in the document WO 00/68298. Use may be made of any combination of thermoplastic polymer which is linear, star, H, tree, or hyperbranched copolyamide as described above.

The polyamide has per chain terminal amine and/or carboxylic acid groups, and may possibly comprise terminal groups blocked by the action of agents which block the polyamide chain, in particular by alkylamide functions. Chain blocking agents include those selected from monoacids such as acetic acid, benzoic acid, propionic acid, hexanoic acid, and 3-sulfobenzoic acid sodium salt, or else monoamines such as hexylamine or laurylamine.

The polyolefin preferably has a number-average molar mass Mn PO of between 2000 and 8000 g/mol.

The polyolefin used in the process of the invention has per chain a single function X situated at the end of the polyolefin chain, this function X being capable of reacting with an amine and/or carboxylic acid function of the polyamide.

The polyolefin is defined as a homopolymer or copolymer of alpha-olefins or of diolefins, such as, for example, ethylene, propylene, but-1-ene, oct-1-ene, and butadiene.

Examples include the following:
homopolymers and copolymers of polyethylene, more particularly LDPE, HDPE, LLDPE (linear low density polyethylene), VLDPE (very low density polyethylene), and metallocene polyethylene;
homopolymers or copolymers of propylene;
ethylene/alpha-olefin copolymers such as ethylene/propylene, EPRs (abbreviation for ethylene-propylene rubbers), and ethylene/propylene/diene (EPDM);
styrene/ethylene-butene/styrene (SEBS), styrene/butadiene/styrene (SBS), styrene/isoprene/styrene (SIS), and styrene/ethylene-propylene/styrene (SEPS) block copolymers; and
copolymers of ethylene with at least one product selected from the salts or esters of unsaturated carboxylic acids, such as alkyl (meth)acrylate (for example, methyl acrylate), or the vinyl esters of saturated carboxylic acids, such as vinyl acetate.

The polyolefin has per chain a single function X situated at the end of the polyolefin chain, this function X being capable of reacting with an amine and/or carboxylic acid function of the polyamide.

The function X may be selected, for example, from the group consisting of:
acid anhydrides capable of bonding covalently with the terminal amine groups of the polyamide, forming imide and/or amic acid functions;
1,2-position diacids (hydrolyzed form of an acid anhydride) capable of bonding covalently with the terminal amine groups of the polyamide, forming imide and/or amic acid functions;
amines capable of bonding covalently with the terminal carboxylic acid groups of the polyamide, forming an amide bond;
carboxylic acids capable of bonding covalently with the terminal amine groups of the polyamide, forming an amide bond;
acid chlorides capable of bonding with the amines of the PA, forming an amide bond; and
epoxies capable of bonding covalently with the terminal amine and/or acid groups of the polyamide.

The functions X which form imide, amic acid, and amide bonds are preferred on account of their high stability. The functions X of acid anhydride type are particularly preferred.

According to one particular embodiment, the functions X allow the formation of imide bonds. These functions X may therefore be selected from cyclic acid anhydrides, especially those comprising a 5- or 6-membered cyclic anhydride unit, and 1,2-dicarboxylic acids.

The imide bonds may make it possible to obtain copolymers having enhanced properties, particularly in terms of thermal stability.

This function X may be fixed at the end of the chain of the polyolefin by grafting or copolymerization of an unsaturated monomer which carries the function X.

Polyolefins which carry a function X, according to the invention, include in particular the following compounds: polyethylenes and copolymers terminated by carboxylic monoacid, monoamine, monoanhydride, dicarboxylic acid in 1,2-position, polypropylenes and copolymers terminated by carboxylic monoacid, monoamine, monoanhydride, dicarboxylic acid in 1,2-position, ethylene-propylene rubber (EPR) elastomers terminated by carboxylic monoacid, monoamine, monoanhydride, dicarboxylic acid in 1,2-position, ethylene-propylene-diene (EPDM) elastomers terminated by carboxylic monoacid, monoamine, monoanhydride, dicarboxylic acid in 1,2-position, copolymers of ethylene with at least one product selected from salts or esters of unsaturated carboxylic acids such as esters of (meth)acrylic acid, for example methyl acrylate, or vinyl esters of saturated carboxylic acids, such as vinyl acetate, the proportion of comonomer by weight possibly reaching 40% by weight, styrene/ethylene-butene/styrene (SEBS), styrene/butadiene/styrene (SBS), styrene/isoprene/styrene (SIS), and styrene/ethylene-propylene/styrene (SEPS) block copolymers.

The molar number of the function X, denoted nX, may be measured by potentiometric assay and/or by NMR analysis.

The relation nX/nY is between 0.8 and 1.2, more preferably between 0.9 and 1.1.

According to one embodiment, the process employs a polymer blend in which the amount of polyamide constituting the backbone and of polyolefin constituting the graft or grafts is greater than or equal to 80% by weight, in particular greater than or equal to 90% by weight, more particularly greater than or equal to 95% by weight, or even greater than or equal to 99% by weight, relative to the total weight of the polymers.

According to one particular embodiment, the blend of polymers employed is composed of at least one, more particularly one, polyamide constituting the backbone and of at least one, more particularly one, polyolefin constituting the graft or grafts.

### COPOLYMER OF THE INVENTION

The present invention also relates to a polyamide-polyolefin block copolymer composed of a polyamide backbone and of one or more polyolefin grafts on said backbone; in which:
the copolymer has a number-average molar mass Mn CP of between 5000 and 40 000 g/mol;
the polyamide backbone has a number-average molar mass Mn PA of between 1000 and 30 000 g/mol;
the polyolefin graft or grafts have an average molar mass Mn PO of between 500 and 10 000 g/mol;
Mn PA is greater than or equal to Mn PO;
the polyolefin graft or grafts are attached to the backbone by the residues of a function X-Y; obtained from the reaction of a function X capable of reacting with an amine or carboxylic acid function Y of the polyamide.

The X-Y functions are preferably amide or imide functions, and more particularly imide functions.

The number-average molar mass Mn CP may be measured by GPC. In order to define the number-average molar mass Mn PA and the number-average molar mass Mn PO within the copolymer of the invention, an NMR may be carried out, in particular so as to determine:
the number of bonds between the polyamide and the polyolefin, as for example for determining the number of imide functions;
the number of terminal groups of the polyamide and of the polyolefin that are not engaged in the reaction and are not covalently bonded, corresponding to the quantity of chain ends of the copolymer, and also giving the number-average molar mass Mn CP; and/or
the number of repeating polyamide and polyolefin units, thereby gaining access to number-average molar mass Mn PA and the number-average molar mass Mn PO.

Very particularly, the copolymer has a terminal amino group—TAG—content of from 20 to 500 meq/kg.

The invention also relates to a composition comprising at least one polyamide-polyolefin block copolymer according to the invention.

According to one subject of the invention, this composition comprises, in particular, the polyamide-polyolefin block copolymer according to the invention as thermoplastic polymeric matrix, and does not comprise other thermoplastic polymeric compounds. The invention also relates to a composition comprising at least one thermoplastic matrix which is solely composed of a blend of polyamide and of polyamide-polyolefin block copolymer of the invention.

The composition may comprise an amount of copolymer according to the invention of greater than or equal to 90% by weight, relative to the total weight of the composition.

The composition may comprise an amount of copolymer according to the invention and of its precursors of greater than or equal to 90% by weight, more particularly greater than or equal to 95% by weight, very particularly greater than or equal to 99% by weight, relative to the total weight of polyamide and of polyolefin, or even consists of copolymer according to the invention.

Furthermore, the composition may comprise an amount of polymer(s) other than the copolymer according to the invention and its precursors of less than or equal to 20% by weight, in particular less than or equal to 10%, more particularly less than or equal to 5% by weight, and very particularly less than or equal to 1% by weight, relative to the total weight of polymers.

According to one particular embodiment, the composition comprises an amount of polyolefin, in particular devoid of function X, of less than 20% by weight, in particular less than 10% by weight, very particularly less than 5% by weight, relative to the total weight of the composition.

A composition of this kind may comprise one or more additives or compounds selected from the group consisting of matting agents, heat stabilizers, light stabilizers, pigments, dyes, reinforcing fillers, such as glass fibers or mineral fibers, glass beads, and carbon fibers, nucleating agents, and impact reinforcement agents such as elastomers, various metals, and anticaking agents or agents that aid molding.

The copolymer of the invention, or a composition comprising it, may be used as raw material for supplying diverse methods for manufacturing known plastics articles, such as injection, extrusion, and extrusion blow-molding methods.

The invention also relates to articles obtained by shaping the composition of the invention, by any technique of plastic transformation, such as, for example, by extrusion, such as, for example, extrusion of sheets and films or blow-molding extrusion; by molding such as, for example, compression molding, thermoforming molding or rotational molding; or by injection such as, for example, by injection molding or by injection blow-molding.

According to another of its aspects, the invention further provides for the use of a copolymer according to the invention as a viscosity agent for solution, more particularly aqueous solution, of acid. These acids may be inorganic or organic.

Said inorganic acids may be selected from hydrochloric, hydrofluoric and sulfuric acid. Said organic acids may be selected from formic and acetic acid.

The concentration of acid may be at least 3%, in particular at least 5%, by weight, relative to the total weight of the solution. Very particularly, the concentration of acid may be from 3% to 28% by weight, and more particularly still from 5% to 25% by weight, relative to the total weight of the solution.

Said invention further provides an acidic solution, in particular as described above, comprising a copolymer as defined in the present description. Said solution may comprise the copolymer in an amount of from 0.01% to 5% by weight, in particular from 0.1% to 3% by weight, relative to the total weight of the solution.

Said invention likewise provides for the use of a solution as defined above in a method for petroleum extraction, more particularly for the purpose of increasing the size of the pores and of enhancing the permeability of a rock matrix in formations comprising hydrocarbons.

A specific language is used in the description in order to aid comprehension of the principle of the invention. Nevertheless, it should be understood that no limitation of the scope of the invention is envisioned by the use of this specific language. Modifications and improvements can in particular be envisaged by a person conversant with the technical field concerned on the basis of his own general knowledge.

The term “and/or” includes the meanings “and” and “or” and all the other possible combinations of elements connected with this term.

Other details or advantages of the invention will become more clearly apparent in the light of the examples given below purely by way of indication.

### EXPERIMENTAL SECTION

Characterizations

The polyamides used for preparing PA-b-PP block copolymers are as follows:
PA1: polyamide 6 characterized by TAG=65.1 meq/kg and TCG=65.5 meq/kg, or an Mn=15 300 g/mol.
PA2: polyamide 6 characterized by TAG=62.2 meq/kg and TCG=64.3 meq/kg, or an Mn=15 800 g/mol.
PA3: polyamide 66 characterized by TAG=104.9 meq/kg and TCG=32.7 meq/kg, or an Mn=14 500 g/mol.

The amount of terminal acid groups (TCG) and terminal amine groups (TAG) is determined by potentiometric assay and is expressed in meq/kg. The number-average molar mass Mn is determined by the formula Mn=2.10⁶/(TAG+TCG), and it is expressed in g/mol.

For the polyolefins, we used polypropylenes monofunctionalized with anhydride at the chain ends, supplied by Baker Hughes Petrolite, Polymer Division, under the names X-10065 (Mn˜1000 g/mol), X-10088 (Mn˜2500 g/mol), and X-10082 (Mn˜8000 g/mol). The structure of these functional polypropylenes is described in the formula below and they are characterized by the amount of acid functions, expressed in mg KOH/g. The concentration of anhydride functions, TAhG, expressed in meq/kg, is calculated by the formula:

TAhG=amount of acid functions×1000/(2×M_{KOH})

where M_{KOH} is the molar mass of potassium hydroxide KOH, taken as being equal to 56.11 g/mol.
PP X-10065: amount of acid functions=100, or TAhG=891 meq/kg
PP X-10088: amount of acid functions=40, or TAhG=357 meq/kg
PP X-10082: amount of acid functions=15, or TAhG=134 meq/kg

The melting (or fusion) temperature (T_{f}) and the associated enthalpy (ΔHf) is determined by differential scanning calorimetry (DSC) by means of a Perkin Elmer Pyris 1 instrument, at a rate of 10° C./min. The thermal stability is evaluated by ThermoGravimetric Analysis (TGA) by means of a Perkin Elmer TGA7 instrument which operates by measuring the loss of mass of a sample of a few mg which is heated at 10° C./min under inert gas (nitrogen).

Microscopic analysis carried out on MET Tecnai FEI. The amorphous phase of the polyamide is labeled with phosphotungstic acid by a method described in the literature.

Preparation of PA 6-b-PP and PA 66-b-PP Block Copolymers

Before the preparation of the copolymers, the polyamides are dried to give a water content of less than 2000 ppm. The PA6-b-PP (or PA66-b-PP) block copolymers are realized by introducing polyamide PA 6, or PA 66, and monofunctional polypropylene into a DSM MIDI 2000 micro-extruder (“micro-compounder”) (15 cm³) which is heated at a temperature of 250° C. for the PA 6 or 280° C. for the PA 66 copolymers. The test rotary speed of the twin screws is 100 or 250 revolutions per minute. This micro-extruder contains a recirculation loop for the melted material, which makes it possible to regulate the residence time. Three residence times were selected: 2, 6 and 10 minutes. The quantities by mass of polyamide and of PP introduced into the micro-extruder are determined so as to have the same molar amount of amine carried by the PA and of anhydride carried by the PP.

Irrespective of the blend, the extruded rods possess a transparency similar to that of the original polyamide or even, in certain cases, more transparent than the polyamide. For comparison, a reference blend of PA/PP/maleic anhydride-grafted PP—PP-g-MA—compatibilizer, Orevac, is opaque.

Examples Ex1, Ex2, Ex3, Ex4, Ex5, and Ex6 were carried out with a screw speed of 100 revolutions per minute. Examples Ex1a, Ex2a, and Ex3a were carried out with a screw speed of 250 revolutions per minute.

The compounds used are given in Table 1:

TABLE 1

| | Ex 1 | Ex 2 | Ex 3 | | | |
|---|---|---|---|---|---|---|
| | Ex 1a | Ex 2a | Ex 3a | Ex 4 | Ex 5 | Ex 6 |
| PA1 | 84.6% | 84.6% | 84.6% | — | — | — |
| PA2 | — | — | — | 93.5% | 68.2% | — |
| PA3 | — | — | — | — | — | 77.3% |
| PP X-10065 | — | — | — | 6.5% | — | — |
| PP X-10088 | 15.4% | 15.4% | 15.4% | — | — | 22.7% |
| PP X-10082 | — | — | — | — | 31.8% | — |
| nX/nY | 1 | 1 | 1 | 1 | 1 | 1 |
| Residence time | 2 | 6 | 10 | 6 | 6 | 6 |
| (min) | | | | | | |

Solubility Analysis of the PA6-b-PP Copolymers

PA 6 is soluble in formic acid, whereas PP X-10088 is not. The copolymers of examples 1, 1a, 2, 2a, 3, and 3a are themselves completely soluble in formic acid, thereby demonstrating the existence of copolymers formed during the melt-route blending. Moreover, an increase in the viscosity of formic acid through the addition of the block copolymer of examples 1, 1a, 2, 2a, 3, and 3a is observed, even at a very low concentration, of the order of 1%. This is also the case for the copolymer of example 4, which is completely soluble in formic acid, whereas PP X-10065 is absolutely not soluble in formic acid.

In a conventional PA/PP blend, there is no solubility of the PP dispersed in a PA matrix.

Complete solubility of the copolymers is required for certain article manufacturing processes that require a first step of dissolution, such as spread coating, surround coating, or electrostatic spinning.

Microscopic Analysis of the PA-b-PP Copolymers

Microscopic analysis shows that the PA and PP blocks are segregated and undergo organization at a scale of several tens of nanometers. This is referred to as nanostructurating of the PA-b-PP block copolymers. Comparison of the structures of the copolymers from examples Ex1, Ex2, and Ex3 and Ex1a, Ex2a, and Ex3a shows identical nanostructurating irrespective of the extrusion time and the shear (rotary speed of the screws), hence showing that:
the coupling reaction between the polyamide and the PP is very rapid and takes place in less than 2 minutes' residence time within the extruder, irrespective of the rotary speed of the screws.
the nanostructuring is stable for at least 10 minutes of time spend in the melt state, corresponding to a time equivalent to a number of molding or extrusion cycles in the melt state.

It is clearly known in the prior art that the properties of conventional blends such as PA/PP vary with the morphology of the blend, which may change depending on the conditions of use and of re-use in the case of recycling. Accordingly, it is difficult to obtain a blend with a morphology which is both controlled and independent of the blending conditions and which is stable during shaping and reshaping on recycling in particular.

In contrast, according to the present invention, the nanostructuring obtained is independent of the conditions of use, thereby providing a major advantage relative to the present solutions, since it can be obtained after a number of cycles of remelting/reuse.

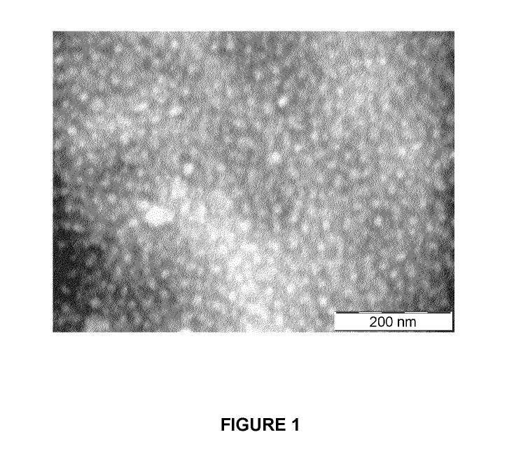

The structuring of the copolymer of example 3 is shown in FIG. 1: the PP blocks are assembled to form spheres or “micelles” with a diameter of approximately 20 nm, which are clearly apparent in this figure.

ThermoGravimetric Analysis (TGA)

Thermogravimetric analysis of PA 1, of PP-X10088, and of the copolymer of example 3 is carried out to 1000° C. The copolymer of example 3 is observed to possess the same thermal stability as a polyamide 6 (loss of mass from a temperature of 380° C.), whereas the PP X-10088 has a limited thermal stability (loss of mass from a temperature of 220° C.). Accordingly, by means of the copolymerization of the present invention, it has been possible to enhance the thermal stability of the polyolefin.

Thermal Analysis of the PA-b-PP Copolymers

The analysis of the melting point of PA (Tf1 PA) and of PP (Tf1 PP) is carried out on the first temperature rise (Tf1) up to 300° C. A plateau of 5 minutes at 300° C. is used, and a temperature descent down to 40° C. is performed. A second temperature rise is carried out up to 300° C., and the melting temperature of the PA (Tf2 PA) and of the PP (Tf2 PP) is taken again. In this way an evaluation is made of the stability of the thermal properties of the copolymers following remelting.

TABLE 2

| | PA6 | PP X-10088 | Ex1 | Ex2 | Ex3 |
|---|---|---|---|---|---|
| Tf1 PA (° C.) | 223.4 | — | 222.9 | 222.9 | 222.9 |
| ΔHf1 PA (J/g) | 64.5 | — | 64.0 | 61.6 | 58.5 |
| Tf1 PP (° C.) | — | 136.5 | 112.3 | 115.6 | 115.5 |
| ΔHf1 PP (J/g) | — | 46.5 | 1.3 | 1.1 | 1.7 |
| Tf2 PA (° C.) | 220.9 | — | 220.4 | 221.1 | 220.3 |
| ΔHf2 PA (J/g) | 63.5 | — | 57.8 | 60.0 | 56.6 |
| Tf2 PP (° C.) | — | 130.5 | 112.0 | 115.8 | 112.6 |
| ΔHf2 PP (J/g) | — | 49.8 | 1.9 | 1.8 | 2.2 |

It is observed first of all that the crystallization of the PP blocks is perturbed (degree of crystallinity of the PP less than that of the PP alone) because of the nanostructuring, which tends to insulate the PP blocks and to prevent them forming spherulite-type crystalline macrostructures. At the same time, the PA 6 blocks crystallize as well as if they were alone; therefore, the PA 6 blocks are not greatly affected by the presence of the PP blocks. The thermal properties of the PA 6 block is therefore conserved, but not that of the PP.

It is also observed that the thermal signature of the copolymers is identical to that subsequent to remelting, thereby demonstrating the stability of the PA-b-PP block copolymers of the invention after a number of melting cycles.

Analysis of Water Uptake

The analysis of water uptake by extruded rods is performed by immersing 1 g of extruded rods in a beaker filled with water at ambient temperature. The ponderal water uptake, expressed in %, is determined by the following formula:

ponderal water uptake=(mass at time t−initial mass)/initial mass

At different analysis times, the rod is withdrawn, wiped with absorbent paper, and weighed to determine the ponderal water uptake as a function of time. It is then replaced in the beaker for continuation of analysis. The ponderal water uptake at saturation is ascertained when the ponderal water uptake is constant with time.

It is clearly observed in this way that the water uptake of the PA6-b-PP block copolymers is slowed. It is shown, accordingly, that the particular organization of the PA-b-PP block copolymers gives rise to water uptake which is different from that of a simple polyamide and of polyolefin.

Applications Properties

5 kg of block copolymer similar to that of example 1 are produced by extrusion of PP X-10088 (feed vessel 1: 900 g/h) and PA 6 (feed vessel 2: 5100 g/h) referenced PA1 on a Leistritz LSM twin-screw extruder (barrel diameter 34, L/D 33.5) operating at 100 rpm and preheated and regulated so as to have a melt temperature of 247° C. Degassing is carried out in order to remove the water of reaction produced. At the extruder outlet, the rod is immersed in water, solidified, and pelletized, and then dried overnight under vacuum at 90° C. before use.

The block copolymer pellets prepared in this way are analyzed by a variety of techniques. They are fully soluble in formic acid, a sign of reaction of the PP block with the PA block. Rheological analysis is carried out at 250° C. using a Göttfert 2002 capillary rheometer. It is apparent that the block copolymer has a melt viscosity profile (table 3) as a function of shear rate that is very different from that of the PA1 from which it originated:
the viscosity at low shear rate (<250 s-1) of the copolymer is broadly greater than that of PA1
the copolymer does not exhibit a Newtonian plateau at low shear rates (that is, a constant viscosity irrespective of the shear rate), whereas PA1 does exhibit a Newtonian plateau.

The result is all the more surprising given that the copolymer exhibits a melt viscosity which is broadly greater than that of a polyamide having an equivalent number-average molar mass (MnPA1+MnPPX10088). This behavior is therefore explained by the particular structuring of the block copolymers.

This behavior is desired in order, for example, to carry out extrusion blow molding (high viscosity at low shear rate) and injection (low viscosity at high shear rate, similar to that of PA1).

TABLE 3

| | η in Pa · s at | |
|---|---|---|
| | 250° C. | η in Pa · s at |
| Shear rate | PA6-b-PP | 250° C. |
| in s-1 | (Ex7) | PA1 |
| 5000 | 83 | 86 |
| 2500 | 131 | 132 |
| 1000 | 228 | 208 |
| 500 | 340 | 263 |
| 250 | 519 | 303 |
| 100 | 985 | 346 |
| 50 | 1466 | 366 |
| 25 | 1970 | 391 |
| 10 | 2762 | N.D. |

The pellets of block copolymer are injected on an Arburg press in a mold regulated at 75° C., in the form of test specimens with a thickness of 4 mm. The temperature at the head of the injection nozzle is set at 254° C. It is apparent that injection is stable and very easily produces test specimens exhibiting an attractive surface appearance.

Dynamic mechanical analysis at a temperature of −100° C. to 200° C. is carried out on a Rheometrics Solids Analyzer (RSA II) rheometer at a frequency of 1 Hz and a deformation of 0.01%. The following are then observed:
the presence of the alpha transition temperature of the PP block, which is difficult to determine with precision owing to the small amount of the PP blocks, but which is situated at between −20° C. and 0° C.
a decrease in the alpha transition temperature of the PA, going from 68° C. for PA1 to 62° C. for the PA block of the block copolymer, associated with the linking to a PP block of low Tg.
a modulus at the rubbery plateau at 150° C. going from 580 MPa for PA1 to 365 MPa for the block copolymer.

The PP therefore provides the PA block with flexibilization.

Tensile measurements (ISO527/1A) are performed at 23° C. on the block copolymer. A tensile modulus of 2600 MPa (as against 2900 MPa for PA 1) and a breaking stress of 65 MPa are obtained.

1. A process for producing a polyamide-polyolefin block copolymer, the process comprising conducting the following in a molten state:
a polyamide having a number-average molar mass Mn PA of between 1000 g/mol and 30 000 g/mol; wherein the polyamide has per chain terminal amine and/or carboxylic acid groups;
a polyolefin having a number-average molar mass Mn PO of between 500 g/mol and 10 000 g/mol; the polyolefin has per chain a single function X situated at the end of the polyolefin chain; this function X can react with an amine and/or carboxylic acid function of the polyamide; and
wherein the proportions by mass of polyamide and of polyolefin employed and their molecular weights are a function of the following relation:
n X/n Y is between 0.8 and 1.2
in which:
n X represents the number of moles of function X of the polyolefin, and
n Y represents the number of moles of the terminal amine and/or carboxylic acid groups of the polyamide capable of reacting with the function X to form a covalent bond, and wherein the resulting polyamide-polyolefin block copolymer is composed of a polyamide backbone and one or two polyolefin grafts on said backbone.

2. The process as defined by claim 1, wherein the polyamide is selected from the group consisting of PA 6.6, PA 6.10, PA 6.12, PA 12.12, PA 10.10, PA 10.2, PA 4.6, MXD.6, PA 6, PA 7, PA 11, PA 12, and PA 13.

3. The process as defined by claim 1, wherein the polyolefin has a number-average molar mass Mn PO of between 2000 g/mol and 8000 g/mol.

4. The process as defined by claim 1, wherein the function X is selected from the group consisting of:
acid anhydrides that can bond covalently with the terminal amine groups of the polyamide, forming imide and/or amic acid functions;
1,2-position diacids that can bond covalently with the terminal amine groups of the polyamide, forming imide and/or amic acid functions;
amines that can bond covalently with the terminal carboxylic acid groups of the polyamide, forming an amide bond;
carboxylic acids that can bond covalently with the terminal amine groups of the polyamide, forming an amide bond;
acid chlorides that can bond with the amines of the PA, forming an amide bond; and
epoxies that can bond covalently with the terminal amine and/or acid groups of the polyamide.

5. The process as defined by claim 1, wherein the function X is fixed at the end of the chain of the polyolefin by grafting or copolymerization of an unsaturated monomer carrying function X.

6. The process as defined by claim 1, wherein the polyolefin carrying a function X is selected from the group consisting of: polyethylenes and copolymers terminated by carboxylic monoacid, monoamine, monoanhydride, dicarboxylic acid in 1,2-position, polypropylenes and copolymers terminated by carboxylic monoacid, monoamine, monoanhydride, dicarboxylic acid in 1,2-position, ethylene-propylene rubber elastomers terminated by carboxylic monoacid, monoamine, monoanhydride, dicarboxylic acid in 1,2-position, ethylene-propylene-diene elastomers terminated by carboxylic monoacid, monoamine, monoanhydride, dicarboxylic acid in 1,2-position, copolymers of ethylene with at least one product selected from salts or esters of unsaturated carboxylic acids such as esters of (meth)acrylic acid, or vinyl esters of saturated carboxylic acids, styrene/ethylene-butene/styrene, styrene/butadiene/styrene, styrene/isoprene/styrene, and styrene/ethylene-propylene/styrene block copolymers.

7. A polyamide-polyolefin block copolymer composed of a polyamide backbone and of one or two polyolefin grafts on said backbone; obtainable by the process as defined by claim 1, in which:
the copolymer has a number-average molar mass Mn CP of between 5000 g/mol and 40 000 g/mol;
the polyamide backbone has a number-average molar mass Mn PA of between 1000 g/mol and 30 000 g/mol;
the polyolefin graft or grafts have an average molar mass Mn PO of between 500 g/mol and 10 000 g/mol;
Mn PA is greater than or equal to Mn PO; and
the polyolefin graft or grafts are attached to the backbone by the residues of a function X-Y; obtained from the reaction of a function X capable of reacting with an amine or carboxylic acid function Y of the polyamide.

8. The copolymer as defined by claim 1, wherein the functions X-Y are amide or imide functions.

9. A composition comprising a copolymer as defined by claim 1.

10. An article obtained by shaping the copolymer as defined by claim 8.

11. An article obtained by shaping the copolymer as defined by the composition of claim 9.
